(19) United States
(12) Patent Application Publication
(10) Pub. No.: US 2002/0032019 A1
(43) Pub. Date: Mar. 14, 2002

(54) Method for assembly of unique playlists

(76) Inventors: Michael B. Marks, South Orleans, MA (US); Joel Marks, Sherman Oaks, CA (US); Derrell Lipman, Billerica, MA (US)

Correspondence Address: Brad I. Golstein, Metro88, 20755 Plummer Street, Chatsworth, CA, 91311, US

(21) Appl. No.: 09/838,330

(22) Filed: Apr. 20, 2001

Related U.S. Application Data
(60) Provisional application No. 60/199,120, filed on Apr. 24, 2000.

(51) Int. Cl. H04M 3/42

(52) U.S. Cl. 455/414; 455/186.2

(57) ABSTRACT

A method of near real time assembly of personalized playlists wherein a limited number of broadcast streams of programming content are assembled into a much larger number of unique playlists. The broadcast streams are available to the user by means of the Internet or other wired or wireless data system, from within or without a cooperative network. Component items from the broadcast streams are buffered at or near a user and identified for potential use as substitutes in a base channel selected by the user. The candidate substitute items are not identified to the user unless and until they are actually played in the personalized playlist. A unique personalized playlist is locally assembled for the user from generic publicly available streams while no uniquely originated stream is required. A customizer directs the assembly of the playlist according to one or both of the preferences of the user, and the style of a station that streams a base channel from which the personal playlist may be assembled. Locally stored content from a CD or other digital media may be used as a source for substitutions in the base channel. The major content of the personalized playlist need not be stored with the user, thus conserving memory resources. The distinct items of the playlist are not individually searchable by the user, remaining unidentified to the user unless they are actually played. In the case of music playlists, minimal local storage and searchability help conform to recording industry rules that discourage searching and downloading of content.

### FIELD OF THE INVENTION

The present invention relates to audio playlists. More precisely the invention concerns efficient methods to compile and deliver customized playlists in near real time.

### BACKGROUND OF THE INVENTION

Audio information and entertainment content are available from multiple sources including broadcast radio, and personal audio collections stored as CD's, MP3 files, tapes and other storage media. Increasingly, audio programming is also available on various Internet web sites. Highspeed data connections are making more of this “Internet Audio” practical to use. Internet audio is often accessed by visiting a web site that provides such programming. A PC computer or similar multi-purpose device is used to select an audio web site and the programming within it. A user must search the Internet and build a “personal playlist” by compiling desired selections and programs from various web sites. Many audio sites require a listener to register with personal information. Internet audio listening is thus similar to many other web surfing activities; at least until a user has made the effort to set up a computer to present and play desired program types.

Some providers have designed or proposed special purpose devices for listening to audio Internet. These include AudioRamp.com, Kerbango, and Sonic Box. Some of these companies are evolving from PC based audio devices to special purpose equipment. These operators typically focus on finding and listening to music.

One design goal in the field of Internet music is to make the listening experience as simple as current practice with FM radio and CD's. Because of the limitless and ever changing programming on the Internet it is unlikely to ever be an entirely simple process to search and find favorite programming there.

Audio broadcast over the radio allows a listener to hear a limited selection of local stations or playlists. Audio delivered by the Internet is greatly expanding audio listening options. However if a user wants a substantially personalized playlist the only method has been to play selections from previously stored items. These may be stored or buffered downloads, or CDs played from a user device, nearby server or jukebox. These items are arranged to fit the taste of an individual listener. However recording industry rules discourage storing music selections or lists with a user unless they have been explicitly paid for. Further, delivery of customized time sensitive information, such as a playlist of news stories, must be in near real time. However delivering personalized playlists to a mass market in near real time has been difficult within the limits of the Internet.

The cited reference “Customized Internet Radio” from Hewlitt-Packard Labs describes a method for precisely scheduling programming to create a “TV-guide-like” list, or user constructed playlist. It is a method of searching for requested programs or specific items of programming. Program items are obtained by dynamically changing radio stations according to a time table and storing or buffering items as required to fit the time table.

### SUMMARY

It is an object of the present invention to provide a listener with a custom personalized playlist. It is another object to reduce the unique data required to construct such a playlist. It is a related object to enable programming from existing FM broadcasters to conveniently lead listeners into personalized Internet programming. It is a further object to make Internet audio programming accessible and familiar to existing users of audio devices. It is another object of the invention to present Internet programming that relates to and expands upon real time selected programs. It is another object to integrate music listening with spoken programming. It is a further object to establish a network of providers of programming and information content that are one or more of: independently owned and operated, linked to non-Internet audio sources, linked to each other, include in common some of a standard program presentation or search format, cooperatively sharing time sensitive resources, accessible using multipurpose address names, and are associated with an identifying name comprising a common name element. It is a related object to provide a unifying theme to Internet audio programming while discouraging a single entity from globally influencing that programming.

In its preferred embodiment, the present invention is used in conjunction with a network of affiliated operators (web, audible or video site) wherein the operators agree to abide by a prescribed set of network protocols including the sharing of programming and compensation therefore. Alternately programming may be obtained without a network.

In one embodiment of the present invention a device identifies audio programming as a listener plays it. Or the programming is identified in advance of being played. Various methods to identify the programming may be used, including pattern recognition and advance notice from the provider. Alternate programming from the Internet is made immediately available on a “sidechannel” wherein the alternate programming relates in a specified way to the listener's action. An active selection may be for example a commercially purchased CD or an FM radio station. The Internet sidechannel may include other music selections in the style of the artist on the CD, or a customized playlist created by the FM station. The sidechannel may include one or more programs from sites on the provider network, including non-Internet audio sources and need not be limited to music. When a listener selects and plays programs from an Internet audio provider, the sidechannel may present further options related to the selection. According to this version of the invention the sidechannel always has available a branch of selections based on what is being played by a user's listening device. However the number of possible branches should be limited to reduce confusion. The sidechannel playlist may be compiled based on preferences determined by which selections the user has previously skipped or deleted.

A listener of programming according to the invention does not need to actively search for any Internet sites to find relevant Internet programming. Instead the user's ongoing reaction to pre-assembled playlists forms the basis for new pre-assembled playlists.

Alternately a user can be switched to a different station or channel wherein a selection to be played from the alternate channel has been pre-identified using various known methods and buffered as a replacement for a possibly undesired item in a current channel. As described above these channels may comprise links to non-Internet audio sources. In this case sidechannels are not created, rather a user is switched between different stations or channels upon each modifying action. A preferred station can be defined by residence time, or how long a user stays there without causing a change to another station. A user is assisted in finding a favorite station with no active switching or program gaps.

The quantity of choices can be limitless. While a small number of selections are presented at any one time, the presentation of sidechannels or other channels may continue indefinitely. Alternately the number of sidechannels may be limited to, for example, just one or two. Such sidechannel limitation would be the norm. In this case a sidechannel's playlist may continue to reflect changing preferences, but further channels will not be created.

Since the options need not be limited to programming from the network affiliates, so limiting them will simplify the listening experience. According to the invention, the programming offered by network affiliates is controlled by each operator of an affiliate audio web site. However the affiliates would incorporate a common user experience or interface. The affiliates may also classify their programming according to a standardized system so that searches, such as sidechannel offerings, would be reasonably predictable. The network operator may enable users to access affiliates audio programming by entering an affiliate's telephone number. When known search methods are applied to the pre-classified selections within the network, the process will be most convenient.

A network affiliate is any identifiable station, organization or entity that assembles or serves program materials in association with other providers of programming. In the present disclosure a station is any distinct or identifiable provider of programming.

Although the affiliates may operate independently, a managing organization or group will ensure that the unified naming method, including common name elements and/or telephone numbers, is applied appropriately to describe or classify member content provider sites. The manager will further provide guidance so that affiliate sites conform to a unified classification scheme and user interface.

Affiliates or program providers need not operate by way of a single site or location. An affiliate or station may be a consolidator of information and programming from sites or nodes distributed throughout the Internet or other data network. Or the station or network may enable the user's own equipment to access information distributed throughout the Internet or other data network. Examples of other data networks include wireless delivery by means a cellular radio system, satellite delivery, a regional broadcast signal, or combination of means. In all such networks, digital data can be delivered to a user device. The user device can further link to data networks by way of wired or wireless systems. For example a user's equipment may receive wireless digital signals from various stations whereby the user's device obtains and buffers replacement selections from these stations or channels.

The affiliates may be required to have their web sites organized to offer prearranged programming immediately upon a user arriving at the affiliate's home page, or main location. No decisions or options are available upon initial user contact. This is similar to present radio listening. However as discussed above the affiliate's playlist could adjust in response to a user's ongoing actions.

An advantage of the present invention is that existing audio providers can leverage their programming experience to help a listener mold a personal playlist in the course of ordinary listening. For example a conventional FM broadcast station currently finds Internet audio to be possibly threatening. That station can use its long experience with programming combined with the method of the invention to guide existing radio listeners seamlessly into Internet audio.

In one embodiment of the invention, an Internet service provider will act as the agent for the network manager in providing audio service. The service provider may provide the hardware that is used to search and play audio selections, including devices at a facility of the provider or equipment at the user. The service provider may further provide billing services in the case that a customer chooses commercial-free subscription service or makes a purchase from an affiliate's web site. In this way a customer registers or sets up the account with the same company that is providing data service. This further simplifies use of the present invention since the customer need not separately buy and configure Internet audio devices.

In assembling personalized music or other playlists it is desirable to minimize the quantity of unique data streams that will be needed. It is also desirable to minimize the need for computer memory near a user when assembling real-time playlists. The quantity of data needed for up to 50 million or more unique Internet listeners could overwhelm even the most up-to-date Internet systems. The quantity of data going to an individual listener is similar regardless of how a playlist is generated. However the data moving through the larger Internet system can expand enormously if every user's playlist originates at a chosen station and the entire unique playlist is streamed through the Internet to the individual user. Instead it is desirable to have a modest number of playlist streams available at most nodes of the Internet, where a unique playlist is assembled locally from pieces of these common lists. To reduce local memory usage, the playlists should be assembled in as near real time as practical. Edge networks such as those provided by Akamai, Digital Island and I-Beam provide examples of alternative methods for achieving this goal.

An efficient method to provide customized playlists is to assemble selections in near real time from parallel broadcast music or program streams. The broadcast, requested, or selected streams are equivalent to “Top Channels” of each contributing station. The selections comprising the individual playlist are taken from one or more of these streams. A selection is played in real time from a streaming playlist, or it is at least partially stored on a user's device in advance of when it is to be played. Alternately the storage may be on a local server, the nearest network point of presence to a user that nearly or directly serves the listener. If a listener wishes to hear any selection other than that on a Top Channel, some audio information must normally be stored since the content has likely been time shifted, or played at a different time than it was broadcast.

According to one embodiment the parallel program streams are available at a server near to a user. Selected programs are taken from this location and delivered to the user. Alternately the parallel streams may be available at a user's device. Programs are selected directly at the user's device. If the user's device is connected to the streams through a unique connection, a high bandwidth connection is required for the user's device. DSL connections, even in combination with an edge network, may not have this capacity. Therefore it may be preferred that only one or a few streams are sent to a user device from a nearby server if local download bandwidth is limited.

The broadcast streams may be available through a non-unique or shared high bandwidth connection, for example by a one way wireless broadcast signal comprising various local top channels, or other large bandwidth one way data connection such as a cable or satellite signal. Using standardized methods associated with digital content the programming within the signal can be identified and buffered.

It is desirable to define the mechanism whereby a station, other playlist provider, and/or the user's device, assembles a sidechannel or similar personalized playlist for a user, in response to the modifying methods of the invention or other needs. A station, other playlist provider, and the user's device can decide amongst themselves where the available resources provide the best location to store additional content. Collectively, the entities providing, selecting and storing at least portions of alternate audio selections available to the user—the station, other playlist provider, user and/or the user's device—include a “customizer”. A station or other third party may direct a customizer which immediate items to include or substitute into a user's playlist. A separate entity or customizer may decide where to store these items. For example a CD or RAM storage may be used to store items for use in a sidechannel.

To assemble a custom playlist in near real time, personalized selections are taken from the other parallel streams. The customizer must be able to identify and select the items on other channels to be played in a user's channel. The selected items should conform to the user's actions and the station's theme or format. Therefore the identity of the contents of each station's Top Channel is made available to the other contributing stations at least slightly in advance. Every station or entity that contributes a Top Channel to the network also cooperates to provide an advance notice of items to be played, and possibly a time of play. The advance notice may be only for the very next item on a playlist rather than for an entire playlist plan. Alternately other known methods may be used to identify an item, such as those provided by Cantametrics, or Tuneprint.com. These methods include sound or pattern recognition of the programming.

In this manner the stations effectively share playlists, where one station's Top Channel stream provides alternate material for another station's sidechannel offerings. By slightly time shifting another station's real time play item or list, the customizer can insert the alternate item into an individual's personalized sidechannel at or near the user's device or audio system. The alternate selections will be limited to items that are being played by other stations near the same time that the customizer needs them. Of course the current station could obtain any item from its own library, but this leads to the problem discussed above where individualized playlists sent across the wide Internet could cause excess bandwidth demands. As discussed above the time shifted selection is stored locally at or near the user so each playlist item need not traverse the larger Internet. Limiting alternate items to those played near the same time limits the memory demands of storing the alternate selections. In the extreme storing an entire day's offerings, or time shifting everything, from many stations would be equivalent to storing whole libraries with the user. User devices, download capacities, or servers can be taxed by such storage requirements. Some elements of a playlist may be stored locally while the present invention remains directed to near real time assembly of playlists that are not substantially stored with a user.

The listener does not need to possess or know what is about to be played on any station. Only the stations or entities that are assembling playlists to be presented to the listener require this information. This makes a custom playlist practical while conforming to recording industry rules that discourage searchable selections.

According to the invention a sidechannel is prepared for immediate play in case the listener removes a selection that is being offered. In one example the next offering is limited to the following item on the current station channel's list. This item would be stored with the user, However if the user removes two or more selections from the current channel he can quickly advance beyond what has been stored or buffered from the current channel. The customizer or station must anticipate the worst-case time lag that might occur in the case of sequential removals. The time lag between what is played on the streaming or Top channel and that played later on the user's device would have to grow large enough to anticipate a worst-case number of sequential removals. This requires much storage at or near the user. Otherwise if the buffer is empty after a series of deletions, the user may have to wait for an entire removed item to finish, with the volume lowered, before an acceptable item plays, or change the station.

However when suitable substitute items are among those being played on other cooperative stations or channels of a network near the same time, only a small amount of buffered material will be needed since one acceptable selection will nearly always be found among them before it is needed. Normally only a portion of one acceptable alternate selection needs to be buffered to anticipate a removal by a user if the alternate is currently streaming on another list. Further the substitute options can be selected by the current station or customizer from a large number of other stations and channels, providing a deeper real time library to work with that can change without special downloads. Of course a listener can switch stations if a selection is not desired. But this is not convenient and usually brings up an item that has already started. By sharing and slightly time shifting Top Channel selections, a group of stations can pool their resources and bandwidth while keeping existing listeners satisfied with varied and desired selections.

This resource sharing can work with various types of programming. Popular music is the most obvious application. Here the selections tend to be short so that an alternate selection will always be about to start somewhere among the cooperative stations. Therefore a small amount of buffer is required to prepare an alternate selection. However with classical music or other long-playing items there may not always be a selection about to start in the network. One solution is for the network provider or some of the participating stations to offer a stream of short, well-liked filler selections. This is currently done on classical stations when a news feed or other fixed time program must be fitted into the playlist. In one case a pleasing compilation that can both be easily played through and broken up could be used. It could be a repetitive loop program. A method specifically for long playing programs is discussed later.

A further application is for talk band or talk style programming. In a news show the items tend to be short, like pop music. A news station or group of stations may stream different news feeds. According to the invention, upon each news item, a suitable alternate item has already been locally stored or buffered in case the user removes the current item. Based on a user's cumulative modify actions the news provider will buffer one or more substitute news stories from another channel. This selection is immediately played when the user rejects an unwanted story. The parallel story playlists could be as simple as the same list that is time shifted on a few separate streams. The streams would vary as the component items are updated. Since news is time sensitive, an unchanging loop playlist would not be desirable. Similarly, preloading many stories with a user would not be desired. A popular story could be played, and updated, repeatedly on a single channel for easy access by various stations or entities.

A further application for the playlist assembly method of the invention is for television or any other visual type of programming. Personalized lists of video programs including news and the like may be assembled from parallel streams of video programming according to the present invention. Proportionately greater bandwidth savings are possible since video requires more bandwidth than audio.

According to the invention a listener can “hit the ground running”. With no computer knowledge or advance decisions required in obtaining devices or programming, varied Internet audio options are passively available to a listener with minimal change in listening habits.

Importantly, by providing a reason to leave an Internet connected device playing for extended periods, Internet information of a general nature becomes conveniently accessible.

A user and/or device ID is associated with actions that modify a playlist or item being played. The customizer and/or station store these actions. An account associated with the user ID includes a user preference that enables the customizer to deliver programming targeted to the user's taste. Each time a user logs onto a site on the network the customizer may enable a station to know the user and his set of preferences. The customizer may use the preferences to create programming alternatives for the given user.

To illustrate use of the design of the invention it is helpful to reference a specific device that is optimized to work with the methods of the invention.

### BRIEF DESCRIPTION OF THE DRAWINGS

FIG. 1 is a schematic representation of a user device for selecting and controlling Internet audio programming.

FIG. 2 is an exemplary schematic of near real time playlist substitution between cooperative stations.

FIG. 3 is an exemplary schematic of a method for searching and playing long play items.

FIG. 4 is a tree diagram showing selection options using the FM band of the invention.

FIGS. 5 to 7 are exemplary displays and control options as they may occur when using the invention with the device of FIG. 1.

### DETAILED DESCRIPTION OF THE ILLUSTRATED EMBODIMENT

The method of the invention does not depend on a specific device type or design to be useful. The detailed disclosure is directed to Internet audio, although the method disclosed here would be applicable to broader multimedia programming including video and other sources of programming.

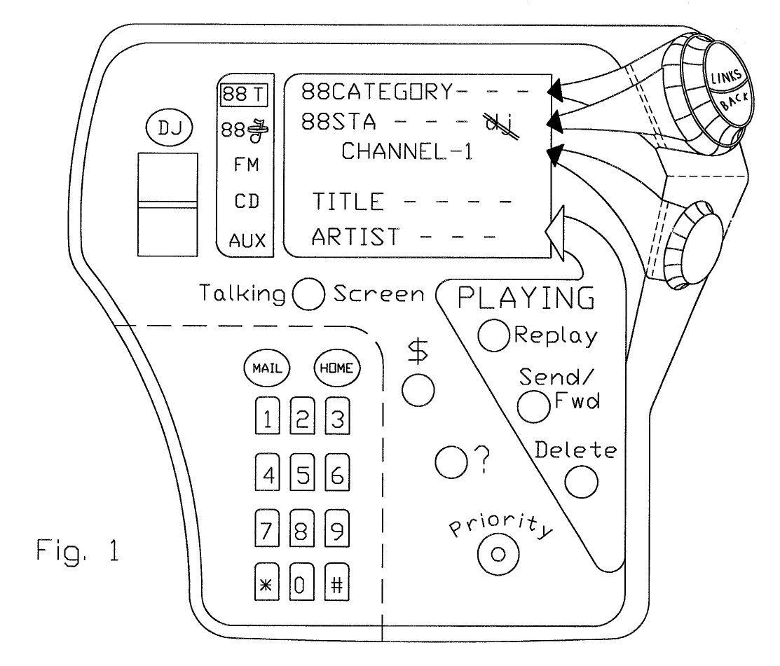

To describe one embodiment of the method of the invention it will be explained in terms of the control device of FIG. 1. The control device may be built into an audio component or it may be a separate wireless unit resembling a remote control. It may be a self-contained personal portable sound system using a wireless Internet connection. It may be a telephone, wireless telephone or equivalent. It may contain or be linked to a customizing feature. It may control a PC or a specialized Internet server appliance. The server appliance may be wired within a home or office, or the server may be linked to a wireless system. The same control device may operate different servers, for example in both a user's home and car. The control device may itself be a server. It may be a virtual device on a PC or similar display screen. It may be a set of protocols used with a device such as a telephone. It may contain, link, or dock to other devices, such as volume controls, audio sound systems, keyboards, personal organizers, speech decoders, cellular phones, multimedia displays and other objects or processes that may be useful with the method of the present invention. The dashed line in FIG. 1 indicates a further device or extra features attached to the control device. A server appliance or component that is controlled according to the method of the invention will be called an “audio system”.

In the case of a telephone like device a numeric keypad may include a template whereby the numbers can be used to search in a manner similar to the controls in FIG. 1. For speech recognition certain words may be assigned to control features for navigation. In the case that the control device is a virtual device on a PC, various other options and features may be available along with the virtual control device. Using special purpose software a user could set up customized lists of programs and information. These could be downloaded to the user's physical control device, such as in FIG. 1, and associated audio system. However it is a feature of the invention that this type of preconfiguring is not required to begin enjoying personalized Internet audio programming.

If the control device is portable so that it controls more than one audio system then a user's listening preferences and identifying information will likewise be portable. Alternately a user could provide identifying data, such as codes, fingerprints, voice, or eye scans, to different control devices to enable access to personalized programming.

Providers of programming may be associated as affiliates of a network. To make the programming most useful the providers should conform to at least some of a standard format or method of organizing information, such as providing program title identity along with the data comprising the programming. This standard will enable a device such as in FIG. 1 to access and arrange programming in a predictable and simple way. The device and method will be particularly designed to work with the network providers, and to efficiently link certain out-of-network providers to the network. For example a CD, FM or AM station can be linked by content to a network affiliate. The link may be by a current program segment or by a more general station format. A certain identifiable song or topic on one of these non-network sources can enable a changeable direct link to a network affiliate or other broadcast stream that provides related material.

Affiliates may comprise existing broadcast stations including radio and TV, their Internet sites, businesses or individuals accessed by phone numbers or other ways, and other audio Internet operators. These affiliates would dedicate a portion of their Internet operation to conform to the standard network format. They would have a regular business accessible outside the network, such as over-the-air FM radio, regular telephone connection, or Internet audio sites. The Internet audio sites may be derived from text and graphics sites. The Internet audio may include a local wireless feed. In a preferred embodiment a format is established such that the text may be rendered into audio in conformance with the standardized network format and protocols. These “regular” operations would be linked to the provider's network site so that a user could use their network versions with the familiar search and presentation method of the network of the invention. Many providers may choose to have programming from only within the network where all such programming follows the network format.

In the Figures an exemplary standard for using Internet audio is disclosed. The control device of FIG. 1 provides ways to search, select, and modify programming. These options operate similarly for different types of programs and providers. The device includes a display to show type of provider, identity of the provider, and current program. The device may incorporate a wireless telephone that is primarily voice activated. This information can also be presented aloud as speech and, in various embodiments, selected by speaking. It may also be selected by pressing an entry from a telephone or PDA keypad or performing other actions on a user interface such as writing with a stylus or blinking an eye. The program sources are classified in a standardized way. The left side of the control has a band selector including five “bands”. A rocker switch moves a rectangular indicator to a selected band. The bands include xxTALK, xxMUSIC, FM, CD, and AUX. The band names can be part of a changeable display to enable bands to be added or removed. The xx portion of a name indicates a common component to the Internet site names that network affiliated providers use. Optionally the xx element may be used with names that are owned and operated by the network operator. These names may apply to broad categories, while the affiliates operate within these categories. Then the affiliate need not use the xx name element, but still must conform to the network format standards. Bands according to one embodiment of the present invention indicate a type of input signal, device used to create the signal, or operator controlling the signal. A further band may be “Phone” to indicate regular phone calls or network enabled phone number site access. Use of this phone band may be distinct from using a telephone itself as a web appliance.

Music and talk are displayed as separate bands rather than at a lower search level since a user typically knows immediately which of the two he is seeking. This simplifies the next level search. However the switch may enable a position between xxMUSIC and xxTALK wherein both are indicated. This allows a user, and certain affiliate stations, to be unspecific about the type programs desired or offered. The resulting searches would be less precise.

The talk and music bands may differ in the type of data signal that serves as a respective source. The music band may require a higher or faster data rate or different data compression methods to maintain audio fidelity than the talk band since talk programming is less sensitive to audio fidelity. Thus the talk and music bands may be technically distinct in a manner analogous to low fidelity AM vs. high fidelity FM radio signals. The data service provider can save bandwidth when a user selects xxTALK instead of xxMUSIC. A programming provider using the music band may have to pay more or generate additional revenue to compensate the network operator or data provider for the higher cost of providing the signal. Likewise, a user listening to the music band may receive more advertising than a user listening to the talk band to allow the provision of “free” content. The opposite may be true if a given talk show is especially popular and the fee for rights to the content is higher than that of music content.

Selecting a link may cause the band to switch automatically. The network format may include advice that an affiliate music site, on the xxMUSIC band, provides an option to reduce or remove DJ and other non-revenue producing talk. The control device shows a button to select on-demand the presence or absence of a DJ. In FIG. 1 the DJ icon in the indicator has a slash showing “DJ off. If a user has selected no-DJ mode, he likely does not want to hear station promotions in a personalized channel either. If a station considers it to be a revenue producing item they may refuse to skip the promotion. However a listener that is using the network by subscription may be especially offended. A compromise can be to show the promotion on the display screen but not announce it. Any revenue producing material can be presented this way. Promotions or advertisements will be less intrusive when only displayed and may cost less to present than audible versions. In other bands, such as talk radio there is no DJ icon since it is not relevant and would not be an option for non-affiliated broadcast operations.

The AUX band may include increasingly unused AM signal sources as a Category. Other Categories may be tailored for features unique to other input devices or formats such as TV, cell phones, navigation units or other technologies that may be fit for use with the method of the invention. If desired, TV, AM and other signal sources, such as “Map” for a navigation function, could be distinct bands.

The main display screen in FIG. 1 shows generically “Category” through “Artist”. Artist is specific to music programming. In a preferred embodiment of the invention method, a specific level of search is associated with a specific input device. Further a single device controls the display of information on a consistent part of the display screen. In FIG. 1 the input devices are rotatable dials. Each dial relates to a pointer printed on the control device housing. The pointers indicate which location or line on the screen each dial controls. The large outer dial may be called a “Category” dial. An inner dial is a separately rotatable “Station” dial. These two dials may be called “Search dials”. A single dial below those two is the “Channel” dial. The dials may be color coded to match colors at the arrow end of the printed pointer to further help associate a dial with its screen position. The arrows points are only graphical indicators. Within the inner Station dial are two non-rotating buttons, “Links” and “Back”. An “undo” function may be assigned to a control option.

A numeric phone style keypad may provide these functions. For example in the top row, 1 and 3 can be a category selector. The second row, 4 and 6 can be station, while 1 and 3 are channel. The two key may be band, “O” is “Links” etc. The star key may be a function key to add a second layer of functions to each number. The network operator may provide a template to show the assignments for the keys. The template may include a reference card and possibly small sticker to attach near each button of the keypad. In this manner a phone may be used to search and/or modify according to the invention. A server or other device connected to the phone or line may respond to the tones from selected keys to enable navigation according to the invention, where the phone may be the audio device

An item in the Station level may be temporarily moved up to the Category level if more detailed navigation ability is desired. Then the station rather than the network occupies the Category level. For example a user could “enter” a station's main operation by pressing Links. The station name moves from the second level to the top level. This may be the equivalent of entering an affiliate's “web site” as relevant to the invention. The station dial can then be used to navigate among the station's or other provider's offerings. This can be useful for program providers that need more interactive features. A user may select this condition as a preset wherein the station's main operation is easily accessed. It may become a new Category of that user's device. Otherwise the station defaults to the usual level on the next visit so that the Category level does not become too cluttered. In general a user may add new Categories and delete preloaded Categories from his device.

Of course other methods to control and communicate information may be used. For example the dial functions could be served by up and down buttons, by the buttons of a telephone or PDA keypad or by voice. Information corresponding to the functions of the dial could likewise be communicated by voice. In one extreme one or two buttons would scroll for a search item, while one of the same buttons would select the search level. As more buttons are added and more levels are displayed, up to a point, it is easier to navigate through the selections. In the illustrated embodiment three dials control three respective search levels. The Category and Station dials are nested to simplify the appearance of the device of FIG. 1. The Channel dial is separate since it may be used more often. The dials preferably have a detent action wherein each click when turning represents a step to an adjacent selection. One full rotation of a dial may provide from 20 to 30 steps, but the number of steps per turn would not vary on a specific dial. Or the step increments may jump in proportion to the turning speed, such as a two-speed dial action. In this way the stepping action and speed is entirely controlled by the user. It should be noted that there are no dedicated labels on the dials of FIG. 1. The only constraint on the function of the dials is the position of the screen that they control. Even this constraint could be violated if a provider had a strong reason to do so. The intent is to maximize the versatility of the device of FIG. 1 while maintaining a consistent and familiar function for the controls of the device for all programs.

The selections could be made with no dials or buttons at all. Rather a touch screen, keyboard or voice recognition with no screen could be used to select or enter items in a search level. However a personally entered random search subject will be unpredictable in comparison to preloaded items that are dialed or dictated in. So a network or affiliate provider would require more sophisticated search capabilities to give useful results to spontaneously entered search items. This becomes analogous to a search performed by a general search engine over the entire Internet. The device and method of the present invention could in fact be used to browse the larger Internet, especially as a voice interactive way of doing so. In fact it is an object of the invention to provide a useful and convenient way to be connected to the Internet. By providing audio programming that invites leaving an associated audio system turned on, other information on the Internet becomes conveniently available through a device used according to the invention. In the immediate disclosure, it is intended to limit the search items to pre-selected subjects that are suitable to being served with audio programming. If searches are based on spoken or typed keywords with preassigned meanings, similar to the names of stations or Categories within the network, then search results will remain predictable.

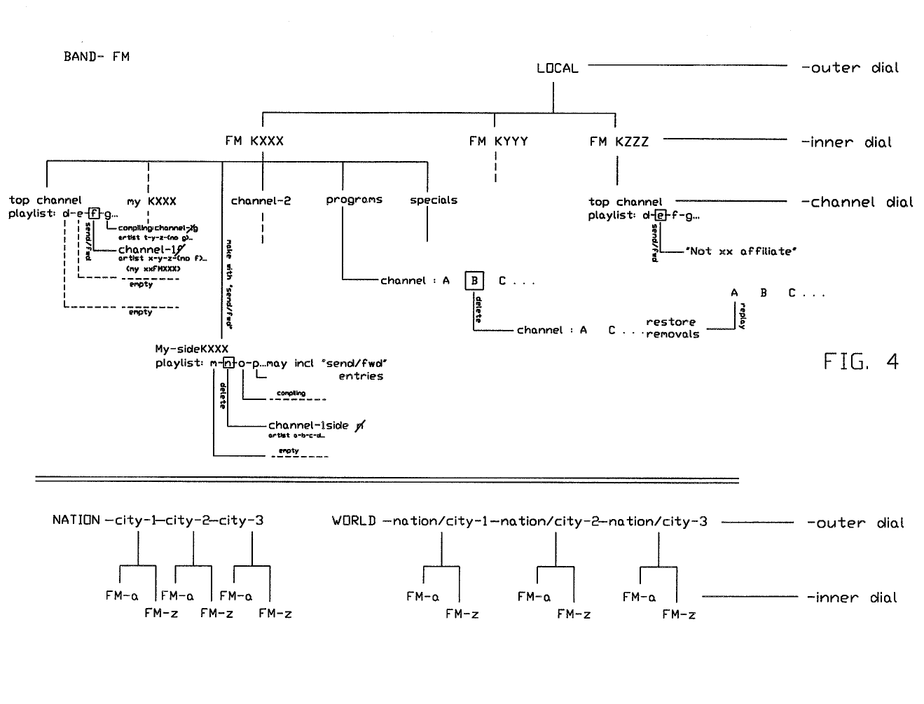

The Category dial controls the top-level subjects. The categories may be the names of sites run by the network operator. Or the categories may describe broadcast station locations or local program sources such as a CD collection. In FIG. 4 the selections for FM band are shown for the “outer dial”. The categories are FM local, FM nation, and FM world. For FM local, the audio system may use the local broadcast signal if it is available. A user can be automatically switched to the station's Internet operation if he does any modify or channel selecting action. Any available Station's signal may be used as a source for programming in response to a modify action. Non-local FM subjects may be delivered by Internet. The nation and world categories may be divided into subcategories such as city or nation/city as shown.

After the local or remote city category is selected with the Category dial, the Station dial selects the FM stations that are available there. For local tuning the station dial works the same as using a conventional radio tuner. The device would preferably be designed so that each detent of the Station dial acts to scan to the next good local station signal or to the Internet sites corresponding to local stations at the given point on the FM radio band. Remote cities could be moved to the higher level by, for example pressing Links, so that the current Category covers only that one city. Then individual stations of that city that have Internet feeds can be selected by using the station dial as if they were local.

The Channel dial can select different channels within a station if they are available. Ignoring the channel option will leave playing the “Top Channel”. The top channel is the station's main playlist. For non-network stations this may be the only option available wherein the channel dial will do nothing. Other channels and playlists will be available if the station is a network affiliate and has implemented this feature of the network format.

If the regular or top channel of a network affiliate station has been selected from the FM band, and the channel of that station is changed by any method, a second band indicator will appear at xxMUSIC, or xxTALK, depending on the type of affiliate station or current program playing. This tells the user that the station is an affiliate and that the benefits of such are available. Tuning back to top channel will remove the xxband indicator to show that the playlist is only from station's FM signal. According to a feature of the invention, an affiliate station largely determines how to classify itself within the limitations of the network format template. In this example that means whether the station, or at least the current program, is music or talk. If the station cannot decide whether its program is music or talk its xxband channels may cause both xxband indicators to appear. However the network operator would discourage this practice since it will not normally be necessary, and could complicate subsequent searching. Also as discussed earlier, using the music band may incur a higher cost than using the talk band because of the respective bandwidth needs.

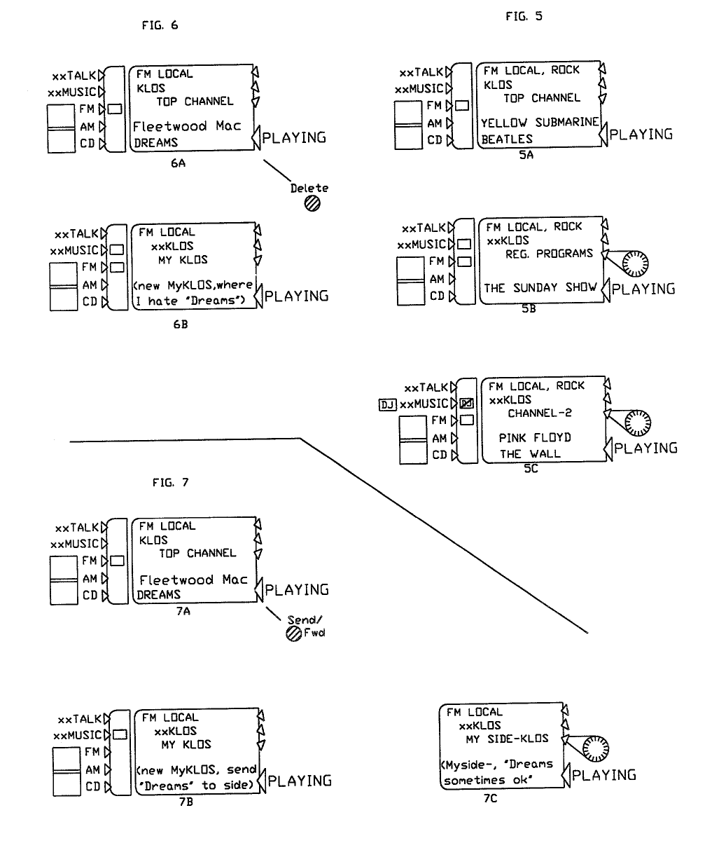

As shown in FIG. 4, the top channel may branch into further channels. FIG. 5 shows an operational example of extra channels being provided by a hypothetically affiliated FM station. A feature of the invention is to have a playlist modified in real time in response to negative inputs. By acting negatively to selections of a playlist, the playlist can be gradually optimized to best suit the listener. However the user does not need to create a playlist or find any selections actively. This is the concept of “hit the ground running” that was mentioned in the Summary section. It means that a listener can mold a station's playlist while listening is under way. By giving most of the weight to negative input according to the invention, the user need not seek nor pick any program selections. Rather he can merely do what is already natural, which is to avoid the offending selections. But rather than lose a listener by his switching to a competing station, the affiliated station allows the user to delete or move aside the currently unwanted selection. However a station may also wish to accept and react to positive feedback such as a priority indication.

A new playlist is planned before each selection is played on the assumption that the listener does not want the upcoming selection. If the user rejects the current selection the modified playlist is ready to begin. If the current selection is allowed to play through, the just prepared playlist is soon discarded since it is not needed. A subsequent playlist based on rejection of the next selection replaces the previous unused list. In a simplified form of modification the new playlist merely excludes the rejected selection from future play.

FIG. 1 shows proposed “modify controls” that may enable the modifying process. They are three buttons within a printed triangle on the device case. It is proposed that these controls be visually associated with the “Playing” pointer since the three control options act most directly upon what is currently playing. By comparison the dial and band controls described before normally provide a broader search or selecting function. The three options are “Replay, Send/Fwd, Delete”. Replay is used to hear a selection again. It may operate similarly to some answering machines wherein tapping it makes the previous selection play while holding it backs up within the selection. Use of this option could indicate that a user especially likes a selection. But it could also be that he was merely curious about some part of it. Therefore it is proposed that negative input according to the two lower buttons is a more reliable way to construct a user's playlist.

Send/Fwd, when used upon a music playlist, skips the current selection to play the next selection. The removed selection is sent to a sidechannel. The current channel list is modified with the knowledge that the user does not wish that selection to be part of it. As discussed above, the modified playlist may already be selected or prepared in case the selection was removed. However the “Send/fwd” control option differs from “Delete” below it since the removed selection forms the basis for an alternate playlist. The user selects the send option when he sometimes is in the mood for the selection, but not as a common or primary choice. The sidechannel thus created has a playlist that evolves from removed selections to reflect the user's “sometimes” mood. An affiliate station would be advised to include enough variety in a sidechannel so that it does not comprise entirely or even mostly selections removed from the top channel, but is rather “flavored” by these selections. In one example, if a music selection by an artist is sent to the sidechannel the current station may play other selections by the same artist, but maybe not the particular one that was sent. The network operator may provide a system for affiliates to use to assemble or select these modified playlists using the station's in-house program material or outside playlist sources. If the listener does not like a selection in the sidechannel list, pressing “Send/Fwd” or “Delete” has the same effect in a preferred method of the invention. Either way the current selection is removed and an alternate item is played. This means that the sidechannel is modified by negative input, but further sidechannels are preferably not created. Otherwise endless branching would become unwieldy.

The “Delete” option removes a selection and indicates the listener never wants to hear it. The deleted selection does not form the basis for any playlist. A new modified playlist is started with the next selection. This modified playlist may be as simple as a station's regular list, but without the deleted item in it. Or it may be another station's regular playlist. Or the new playlist is created in a more sophisticated way based on cumulative negative inputs from a listener to playlist offerings. Such ways may include collaborative filtering or other knowledge based search methods. To maintain an identity a station would not be expected to have or search for playlists to satisfy every listener. Rather, a listener who is deleting many selections from a station would likely choose to turn the dial to another station or another category, if it were not done automatically for him.

If desired “Delete” could also enable removal of an entire modified channel so that it can be created anew. This may be useful if a channel has evolved in a less preferred way or if the user just wants change. For example, if the button is held for a long time while tuned to a sidechannel, the display or audio system will prompt the user “If you want to remove this channel press delete again”.

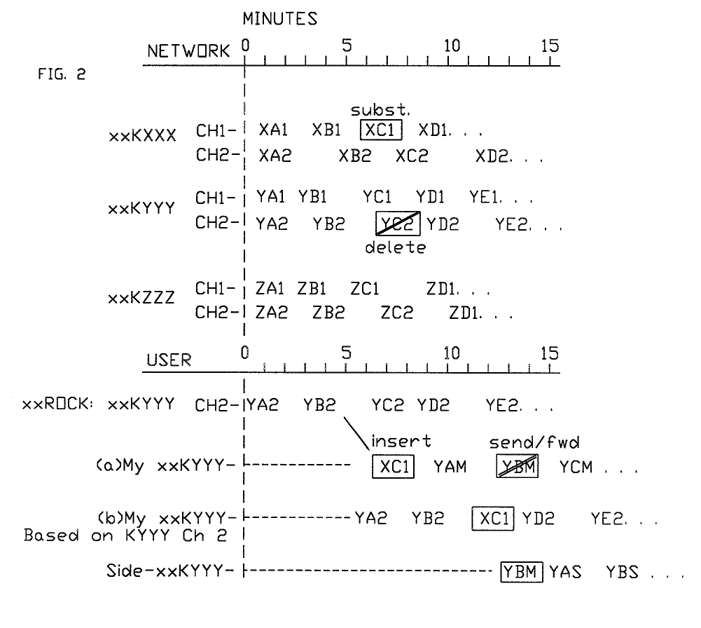

In FIG. 2 an example of creating a personalized playlist in near real time is illustrated. Three affiliated stations in the xxRock category send two music streams, a Top Channel or channel 1, and a Channel 2. Channel 2 is also shown in FIG. 4. In FIG. 2 there are only six parallel real time streams. Normally there can be far more than that. The network operator may determine the available bandwidth for each category or for all categories. For example the Rock category may be allocated room for 100 channel streams. Then if two stations were serving the network in Rock they would each be allowed 50 channels. The local Internet provider at each station may not allow for uploading of that much data from one customer. Then multiple stations, for example 50, providing 2 channels each could fill the need, with more sharing required. In any case having more available channels in a category, such as Rock, will enable the most flexibility in assembling playlists according to the invention. Stations need not be limited to their category when searching for matched selections. But searching may be most efficient if it is limited to channels that fit the current category. Searches further need not be limited to other network station affiliates. For example other Internet stations, a local CD, or an FM or other broadcast stream from various local stations may be used as a source of selections. Non-network stations may not be agreeable or suitable to be sources for content that is used by network stations. A disagreeable station may be a cooperative source of selections if the station's signal is technically suitable for the user's “virtual station” described later.

FIG. 2 stations xxKXXX, xxKYYY, and xxKZZZ each provide a channel 1 and channel 2. A listener is tuned to xxKYYY, channel 2. As selection YC2 plays the user decides to remove it. This sends the listener to a new channel “My xxKYYY”. Selections in the first (a) version here include the letter “M” to signify elements of Channel My xxKYYY. My xxKYYY comes into existence as a result of a modify action; modifying My xxKYYY causes a side channel to be created. Alternately My xxKYYY may comprise mostly the Top channel playlist with only certain selections replaced as shown in the (b) version. Station xxKYYY or the customizer has prepared a selection to be ready in case the user removes YC2. Station xxKXXX has identified in advance its XC1 offering so that xxKYYY, and all stations or customizers can decide whether it is a suitable substitution for a KYYY listener. One criterion for defining a suitable fit is the type of music relative to a station's self-identity. Another criterion is the start time and length of the prospective inserted item. Note in FIG. 2 that XC1 started slightly before the to-be-removed YC2. The closer the alternate item starts to the start of the item on the current user's channel the less buffer memory is required, since the time shifting is minimized. The time shift between the user's sidechannel and the streaming playlist upon which it is based, or base channel, may increase as the substitutions accumulate since the length of the substitutions will not perfectly match the replaced items in the base channel. The base channel will often be a Top channel. If the sidechannel gets ahead of the base channel, wherein a substituted item or items were too short to fill the time of the item or items they replaced, an extra item can be taken from a parallel stream to fill the time. If it gets behind the base channel, if for example a substituted item was much longer than the item it replaced, an item from the base playlist can be skipped.

In the example of FIG. 2 the (a) version of MY-xxKYYY with the “M” selections may comprise an entirely unique playlist with the “M” selection taken from parallel lists or local memory. The (b) version shows one of KYYY's top channels, channel 2, being used as a base channel for the personalized playlist My-xxKYYY. In this simplified example YC2 has been replaced by XC1, with no other changes to the original channel 2. In this basic example this user's My-xxKYYY is identical to the original channel 2 of KYYY except that he will never hear YC2 unless he switches back to the Top channel, channel 2. As more items are replaced from the basis of channel 2, the user's sidechannel can become more distinct from any other channel.

A station with adequate resources may stream its own multiple “hidden” playlists that may not be accessible as regular channels. Instead they are bases for sidechannels that are used only after a modify action. Or the streams may be “loaned” by other stations, in which case they would likely be directly accessible only when a user is “at” the loaning station. But they would be hidden, meaning only accessible from a modify action, at the “borrowing” station. This could work if the stations agree to cross promotions, payments or other mutually beneficial activities. A user stays with his current station with its identity and advertisers while an unseen link is enabled to the station that is providing the hidden base playlist. In one case any outside but affiliated or cooperative station from whose stream an item or list of items is borrowed would be enabled as a link as the material is played on the borrowing station. The loaning station may not be explicitly identified but could be selected by a user's “Link” action.

As a compromise a borrowing station may allow the loaning station to display or announce the identity of the loaning station to the user as any link is activated. This cross promotion or benefit can be a payment method whereby the station that borrows a list or item compensates the station that loans it. For example a display may show the current station with a subtext appearing when an item or list that originated elsewhere is being played; the subtext can show the name of the station whose playlist is being used as a base.

Instead of loaning playlist items as in FIG. 2, the cooperative stations may loan entire playlists. Each cooperative station can know what has recently played or is playing on another station since this information is shared. So the suitability of another station's list for an immediate need can be evaluated. This could help a station maintain a clear style of openly exposed channels while being adaptable for a more diverse user or customer group. If the hidden playlists have distinct personalities, one of them will more nearly match each user. As a user modifies his playlist different channels can be automatically selected as a base to reduce the need for individual substitutions. A station keeps more diverse customers satisfied, thereby retaining them without publicly straying from mainstream playlists. Of course many users will be satisfied with no or slight modifications to only the Top channel.

This hidden playlist method could be used without any individual substitutions from other playlists or elsewhere, with the user just being switched between them in response to modifying actions. If the channels were all reasonably similar to each other this would not cause a break in style. However by using progressive single substitutions a user can be smoothly shifted to a greater variety of hidden channels without an uncomfortable sudden change from one playlist style to another. According to the invention playlists may be modified to varying degrees ranging from none to some substitutions to entire new playlists, where the alternate material may come from combinations of local device memory, a station's own streams, or another station's streams. Even if a current station has an item in its own library, if it is available when needed only elsewhere, the “elsewhere” can get credit for having it at the right time.

In one version of the invention a station may borrow items or playlists for certain or all of its customers to add variety to its current streams regardless of whether the user has chosen to modify anything. This may be by special instructions to someone's customizer, or to types of customizers.

A further option is for the network operator to provide playlist streams for use by affiliates. The network operator may offer these as part of network owned stations. Or the streams can be hidden playlists for use by other stations or affiliates to assemble near real time custom lists for their own customers. By joining the network a station may obtain access to proprietary playlist streams of other affiliates and/or streams supplied by the network operator.

If desired the network operator or cooperative stations may agree to allow a user to be entirely switched between stations in response to modify actions. However it could be difficult to establish a user's loyalty if the selected station continuously changes.

The network operator may oversee that cooperative stations are sharing the burden similarly. If one station is “borrowing” much more than it is “loaning” it may be removed as an affiliate. Or a payment of some type may be required when borrowing lists. If stations are sharing playlists equally the payments will stay balanced (assuming the value and costs of playlists are equal). A station without original playlists will pay for everything it plays. Likely a “virtual” station would not be allowed to use anyone's Top Channel as is. The cooperative stations should not object if a cooperative virtual station borrows and pays for their lists or streams. But a station that finds one or more other stations are borrowing too often from it may want to raise the cost of doing so, or even prohibit that station or all stations from borrowing entirely.

Other affiliates may treat it in kind. If the station selects to prohibit borrowing all or most of the time it will likely also decide that it does not need lists or items from others either and will join a different network or operate independently. Or the station may stay in the network to use the other benefits such as cross-linked promotions and standardized navigation. Payments as described here between cooperative stations as described are normally separate from artist royalties or other commercial transactions although these obligations may be shared along with playlists. In any case, one of the functions of the network operator is to reconcile the trading of playlists.

However for certain streams, such as unencripted broadcast streams, it may be impractical or impossible to prevent the use of items from that stream. For example the customizer within a user's equipment may assemble playlists from various stations' available top channels including out-of-network signals for use by a user's virtual station, where the user's control device is the server.

A station that supplies playlist streams can include a playlist and station identifier embedded within each item of the stream. In FIG. 2 each selection includes a simplified identifier, the first letter and the last number representing respectively the station that streamed it and the channel of the station it came from. The network operator may help coordinate use of these identifiers. This identifier is different from an artist and title identifier since it assigns credit to the provider that originally included it in an assembled playlist. The artist and title identifier are provided as watermark, fingerprint or other data attached to a selection and sent by a cooperative station to other stations. Or the title data is collected by a user's audio system or created by the audio system using pattern analysis of the sounds within the selection as described by tuneprint.com and others. According to the present concept a selection has two types of value: the value to creators of its content such as royalties or creative rights, and a value to a user of the timing and time availability of its play. The first type, creative value, has well established accounting methods. The second type of value is an object of the present invention. A station with many parallel lists, many loops, popular selections or otherwise useful streams will find many other stations using parts of its playlists. A station can be compensated for streaming the right selections at the right time with proper tracking of the embedded identifier. This value of timing is transitory; an item that has value to a cooperative station or user's customizer one minute may have less or no value the next minute. This can depend on the user's immediate modify actions or the current station's immediate needs for substitute items. If a station finds one of its channels is especially popular as a cooperative playlist source it may raise the cost for others to use it assuming such action is sanctioned by the network and is technically possible.

The customizer may work to identify time-suitable alternate items and memory resources available to store them. It may also store the user's modify history or preferences. Each time a user modifies a playlist the modify action may be coupled with the user's ID (and/or user device ID) to create a programming reference item in a user profile maintained by the customizer or station. Customizers and stations may use programming reference items in the development and choosing of alternate programming for that given user ID. The station may add a station identifier to the customizer so that the customizer will reflect that station's style when making substitutions on that station's behalf. For stations to share playlist resources in near real time they must provide each other some advance notice relative to the actual time of play at the user of what is to be played on their respective channels.

A substitution between stations may operate as follows: The listener is hearing YB2 in FIG. 2. During this time KYYY is preparing for the possibility that the user will reject YC2. So KYYY searches either directly or through a customizer the list of soon-to-be-played offerings on the other channels and stations. The list is a text-only or other simply formatted data source. This ever-changing descriptive list may be obtained from the cooperating stations by the network provider and presented as a comprehensive list to every station. Or it may be created in real time for use in a time delayed playlist. KYYY selects XC1 as a good offering to replace YC2. If the approximate start time for XC1 is known to be slightly before YC2, KYYY need not find any other options. In FIG. 2 XC1 starts at 6 minutes past an arbitrary zero time. YC2 starts at 7 minutes. KYYY or the customizer tells the user's device or server to begin downloading XC1 into a buffer. The user rejects YC2. XC1 immediately starts playing since it is already buffered. The network operator may record the use of KXXX's selection. KYYY may borrow the whole playlist from channel 1 of KXXX in which case “My-KYYY” is based on Channel 1 of KXXX. KYYY may decide to leave all or some of XC1 in the buffer even if YC2 is allowed to finish. XC1 may be played as a substitute when the next or any deletion occurs. Or KYYY may feel that XC1 is a good offering only if it follows a certain item or items in their playlist. XC1 may be saved for use only then. If it is to be stored, KYYY may later take XC1 from its own library when possible to avoid any debt to KXXX. However the number of items that can be held in reserve or buffered will be limited by the memory capacity of the user's device or server as well as the available bandwidth for downloading them.

In the extreme an entire day's or longer alternate playlist could be down-loaded before or as a user is listening, where the selections are taken from one or more streams of the affiliate stations. In this manner a customized playlist is assembled at or near the user's device without a need to send it uniquely to an individual listener. However if this occurred because most of the selections in a channel were being removed, the user will likely choose instead to switch to another station. Before this happens the current station may substitute a different playlist if the cost of doing so is reasonable.

A user or station may intentionally assemble a largely or entirely custom playlist from parallel streams within or without a network. If the user is able to find and choose among the preloaded items or if they are predictably played it could violate recording industry rules that discourage searchable music lists. It is likely that personalized playlists will be a compromise between preloaded items and near real time substitutions, with the content taken from the parallel music streams from available sources. Preloaded items may be held in reserve in case of data interruptions and if a user has indicated through a priority action that an item is important. Preloaded items may reside on RAM storage, CD's, hard disks, or other media.

A priority action may be by pressing the “Priority” button on the device of FIG. 1 as a preferred selection is playing. In response to such an action a station or customizer may seek and/or store the item more often for a given playlist.

Another item that may be substituted is advertisements. Multiple parallel loops or playlists of audio advertisements (commercials) can be available. The customizer may include instructions from the station, network, ad agencies or others to insert ads into a playlist for a non-subscription customer. Or the customizer may remove ads from playlists and replace them with programming for subscription customers or other device users. Substituting programming for commercials this way can be a specific function of the customizer. According to the invention streamed audio ads can be personalized or targeted without the need to send them uniquely to each user.

Returning to the near real time playlist assembly, it may be that the time of play for an upcoming substitute candidate is not known. The list of suitable substitute items may then be created by a customizer where items are preidentified and selected in relation to a time delayed buffered playlist. Maybe it is only known that a station will play it “next”. Station KZZZ may not provide a time of play to preserve their flexibility in inserting ads or announcements or other reasons. Further, delays within the Internet may alter some listed times. If at least the identity of future selections is known the current station or customizer will then select a few suitable “next” options from the other station lists and begin buffering the first one that starts playing. In FIG. 2 ZC1 and ZC2 (not highlighted) are alternate options time wise, ZC2 starting just before YC2. However KYYY does not know the exact start time. KZZZ has provided that ZC1 and ZC2 are next on their respective channels. KYYY or the customizer makes an assumption that one of the two will start before YB2 ends. KYYY or the customizer may monitor more than these two channels.

Either KZZZ selection is an acceptable inclusion for KYYY's channel 2 or the user's My-channel after YB2, although ZC2 is preferred in this example, according to the station or customizer preferences. But the expected times of play for these two are not known. KYYY or the customizer then monitors channels 1 and 2 on KZZZ. ZC1 begins at about 6 minutes. This is comfortably before the maybe rejected YC2 is to begin, or YB2 is to finish. So KYYY begins buffering ZC1. If KYYY had waited for ZC2 to begin there could have been a delay upon rejection of YC2 if both started at 7 min., leaving no time to buffer ZC2. However if ZC2 starts in time just a bit before YC2, KYYY or a related customizer could instruct the user's device to dump the less preferred ZC1 and load ZC2 instead. But at least ZC1 was a sure thing in case ZC2 had not started in time.

A current station or customizer could monitor other channels and store items two or more selections in advance with respect to a typical length of play of an item in a playlist. This may be useful if the identity of selections is not readily available. Memory needs can quickly multiply if additional items beyond substitution options, such as a user's presets and long shows, are buffered for immediate play on other channels.

It is not required that a current station send directives through the Internet to assemble My-Channels. Rather the current station, KYYY in this case, can load a substitution software routine or customizer into or near the user's device whereby items are selected automatically at or near the user. The user's device then creates the modified playlist according to the style of the user and/or current station. If the user's server or device does not receive directives from a station, the identity of future alternate items may not be known. It may be necessary to at least partially buffer substitute candidate items from parallel streams until they are adequately identified. Desirable items can be used or stored, while undesirable items can be dumped as soon as they are identified.

The customizer or substitution preference routine may define a user's preferences based on his modify actions or his active inputs. If the preference defining method is standardized at least within each type or category of programming then various stations can use preference information created on other network stations to better select substitute items. Each station may contribute preference-defining information to a single customizer while, according to the invention, each station may interpret this preference routine differently. Or each station or user may contribute all or part of a customizer unique to that station. Then a listener's loyalty is defined by whose customizer is being used, regardless of where the playlist material is coming from. The customizer being used is likely defined by which station is selected. In the current example the user's preferences are stored locally with the user rather than at a station. A station or the network operator may offer options providing that preference data customizers or user history be stored only on a local device. Then the preference routine need not identify a user to a station, but merely his preferences. Where a user's preferences are stored may be selectable by the user. The preference routine may be as simple as which items have been deleted or sent to a sidechannel. Or it may describe a personalized selecting system that has been provided by a user, maybe as directed by an affiliate web site. A most memory efficient routine may be preferred, which determines where the preferences are stored and how they are defined. A user's device may be identified to a station only as a history or summary of modify actions. Each modify action may be stored in user account maintained by the customizer in conjunction with the user's ID (and/or device ID) as means for assisting in the provision of user defined programming in the future.

A more specific user identity may be desired for participation in benefit programs or other interactive programs. However the level of identity can adjust, or be adjusted, to that needed to declare preferences, receive a benefit or respond to queries.

The customizer may provide functions most relevant to local activities such as memory management, parallel playlist searches and substitution timing options. The customizer may present qualified options to select from to a user or station, or the user or station can add a personalization feature to the customizer. The personalization can be a temporary routine that resides with the customizer only when a user is at the particular station. A station may be a user's own virtual station, where the customizer is guided by the user's own preferences only. In this case the user's control device is itself a server as described earlier that operates the user's audio system. The virtual station may be created by the user's audio system from available Stations and other sources. The virtual station's library may include locally available selections to use for assembling playlists from broadcast base channels.

In FIG. 2 the user creates a sidechannel by pressing Send/fwd as YBM plays on MyKYYY. The new sidechannel is now available if desired. The play items include an “S” to designate an element of a sidechannel. KYYY may choose to use their channels 1 or 2 as the basis for the sidechannel, or they may assemble the playlist largely from the offerings of the other affiliate stations using KYYY's format along with the style of YBM as the basis for constructing the sidechannel.

Additional non-personalized channels can be synthesized by a station, network or user from one or more parallel streams. For example a station with only two channels can offer a “Channel 3” by buffering items as described above and inserting them into a virtual channel. So the invention need not be limited to personalized playlists. However the cooperating stations may expect to be paid for use of their material this way if they retain control of such use.

The playlist creation just described is shown equivalently in FIG. 4. FM band is selected and FM station KXXX Top Channel starts playing. The user does not want to hear selection “f” right now and presses “Send/Fwd”. As described earlier, if the station is not an affiliate or does not at least accept certain basic network protocols, nothing will change and the Top Channel will continue to play unmodified, unless the station is the user's virtual station described above. If KXXX is a network affiliate and wishes to retain the listener, a new playlist “x-y-z . . . ” or at least “x”, can be already prepared in case “f” is removed. The next selection is the first of this new playlist. The new channel is called “My-xxKXXX”, and the xxMUSIC band indicator shows as described before since the modified channel is a feature of the xxRadioNetwork. My-xxKXXX channel is now playing. It can be modified continuously as the listener removes selections. The term sidechannel is used generically to describe either a “My-channel” or a “sidechannel”.

In the present invention a station or other provider can use a top channel or select another real time stream as a basis for a sidechannel. The alternate stream may be borrowed from another affiliate station. But any selection or type of selection within that stream that is known to be not desired by a user will be replaced by a suitable item from other parallel playlists or from local memory storage. The contents of a modified playlist may not be known in advance since substitute selections used in the list are often identified only just as they are needed by methods discussed above. But the sidechannel retains the style of the station, user and/or or customizer that assembles it.

A sidechannel “My-sidexxKXXX” can be assembled, using the Sent selections from the higher channels as a guide. However note that selection “f” is not included in the example sidechannel playlist of FIG. 4. The intent of the invention method is that an affiliate will use a Sent selection as the basis for a “sometimes” playlist. That does not mean that “f” must actually be included in the list even if it is available, but merely that it serves as a guide in creating the list.

Alternately a user may be switched to a different top channel or equivalent playlist stream if a selection is removed from a current list. According to this embodiment a station may lose a listener the moment he modifies the current playlist. The newly prepared playlist described for FIG. 4 KXXX above is a currently streaming list from another channel of KXXX, or a different station or other playlist provider. The user may be switched to a personally prepared playlist. The effect is similar to an automatic channel changer, where a suitable selection from the alternate channel is buffered and ready to play with minimal break or overlap. The user's virtual station may function this way using available signal sources. A customizer of the user can determine which alternate channel is about to play a suitable replacement item and direct that this channel be buffered before it is needed. If the alternate station is a Top Channel of an out-of-network station it is likely that items from the alternate playlist are identified very nearly as they are played, since explicit advance notice may not be available. However as long as items are buffered at least slightly in advance of when needed as provided according to the invention they can be identified before they are to be used.

Normally a live DJ would be available only on the Top Channel, since it could be costly and difficult to provide one on the lower virtual channels. However live announcements not related to the specific playlist would be practical if the station tells a user's customizer to provide room for them. If a DJ is desired on the lower channels a combination of prerecorded, synthesized, and live feeds may be provided. A selection may comprise a package of the specified program combined with a related announcement. This combination can be loaned and played together so that a DJ or similar announcer is available. Or a current station can add their own announcer to a borrowed item. This would help the station to retain an identity.

The affiliate station may offer more that one playlist type channel, shown as channel 2 in FIG. 4. A broadcast FM station would normally not have this option except by Internet or other digital delivery. An Internet station could offer such multiple channels. But the exemplary device of FIG. 1 and the playlist modification methods would not function on the Internet station unless it were using the methods of the invention. A station may offer many parallel channels so that personalized playlists can be assembled using only streams from that station. A user's virtual station would inherently operate this way with the user's audio system functioning as the server to assemble items into playlists of the virtual station from locally available broadcast sources.

A network station will be advised to offer some additional channels. In FIG. 4 these are “Programs” and “Specials”. The Program channel lists regular shows that the station offers. Such shows usually have a title or descriptive name. For example a show might be called “Space Tunes” wherein an hour of mood and electronic music is played every Tuesday night at 8 PM. Or it may be a talk show that airs every night. A particular program can be selected within the program channel. It may be available for immediate play as described below. The affiliate station may choose to offer shows from the past week, or past month, or other option they consider reasonable. They may charge the user a fee to hear programs from long ago, where old programs may be stored in less accessible ways. Paying for archived material is common practice, for example, in newspaper web site services.

In FIG. 4 the Channel dial works to select the program titles. So moving the channel within “programs” will play a specific program. Pressing and holding the replay or send/fwd buttons will advance or move back within a program episode to the extent that the material is accessible in memory or other loops as described below. Tapping the buttons will move to the previous or next episode of a program. Of course most providers will not offer future episodes. If a user returns to an episode that was recently playing, it may be desirable that he is returned to his previous location within that episode. Another tap of the button would move back to the start of the current episode or forward to the start of the next episode. The modify buttons do not select other titles; this function is by the channel dial.

Programs titles that are not desired can be removed from program channel. Pressing delete will remove a selected title, possibly after a warning. A sidechannel or personalized playlist of programs is created. Additional programs or specials may be provided by the station or selected by the customizer based on the user's modifications to the original list of programs. These programs may be presented as a near real time assembled playlist of programs taken from parallel broadcast streams. In the example of FIG. 4 program “B” has been removed from the list. At the end of the list an option to restore the removals is available. In this “restore channel” the user is prompted to press “replay” to undo the remove actions. The original playlist, similar to a Top channel of regular programs, is restored. The user may be allowed to selectively restore specific programs by turning the channel dial to highlight selections that have been deleted, and being prompted to press replay at the highlighted item. Since creating a list of preferred programs from those offered by a station is straightforward, it is not likely helpful to provide a sidechannel of “sometimes desired” items. In this regard, programs are treated differently from music playlists. The “send/fwd” button does not send a program title to another list. However a station may desire to enable some other type of send function for regular programs. A further channel of Specials will not likely have a customizable list since by definition they are irregular events. Instead the channel dial will just allow choosing of titles. The affiliate station will decide how many specials to list and how long to leave them on the list, possibly with a basis of the user's program modifications.

According to the invention, several parallel streams of programs may be broadcast. A specific program may not be available precisely when it is requested. It may be available as a unique download after a buffer delay. However for a popular program these unique downloads could overwhelm the Internet in the same way as described above for music or similar playlists. To keep the selection available on-demand a station or multiple stations or entities can contribute multiple time-shifted streams of the same popular program. For example six streams of a one-hour program can make a program start available every ten minutes. Or a customizer can search parallel streams for programs that the listener may like equally well, such as on similar subjects or by the same moderator. A customizer may preload a program locally that a listener has selected before. Then the latest show or episode will be available for immediate play. For the one-hour show started in parallel broadcast streams every ten minutes only about 10 minutes of it would need to be buffered to ensure immediate play.

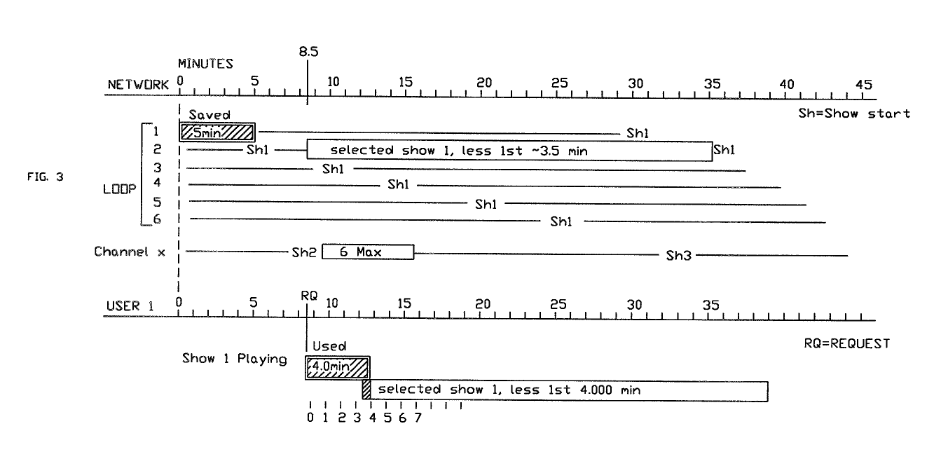

FIG. 3 shows an example of obtaining and playing a half hour “Show 1” with a start time at Sh1. The same show starts every 5 minutes on six parallel streams. A customizer directs that a first 5-minute portion of the show be loaded with the user at some initial time, from loop 1 in this case. This may be when a new episode becomes available for a show that has been selected in the past. The amount loaded will vary depending on how frequently the loops play it. The frequency can be known by monitoring the streams, or more easily, by checking the approximate start times supplied by cooperating providers. At 8.5 minutes past an arbitrary zero time the user requests the show by selecting it on a station's Programs channel or other method. The saved starting portion begins playing. Loop 2 has the most recently started show, about 3.5 min. ago. The loop 2 show is immediately buffered, with about the first 3.5 minutes missing. After playing 3.5 minutes from the saved material, the remaining part from loop 2 is played, with a 3.5-minute time shift. If the 3.5 minutes is precise, the saved and buffered stream can be assembled with no break or overlap. The time-shift of the buffered segment must be precisely known. However such precision may not be reliably available.

Another way to coordinate the separate portions of one show is to insert time markers into any program that is associated with a cooperative or network affiliated provider. For example an inaudible or invisible element of a program can be made detectable by a user device, server or customizer as a precise time reference marker. The time reference marker is used to coordinate the joining of parts of identical programs with similar time reference markers within a program. These markers are shown in FIG. 3 for the attached “playing” portions of show 1. When the user requests the program “Show 1” in FIG. 3 the customizer checks whether a start portion has been saved. It also checks the nearest approximate start time from the list from cooperative providers, about 3.5 min ago for Show 1 on loop 2. The 5 min saved portion is comfortably longer than 3.5 min. The saved portion from loop 1 starts playing and loop 2 is buffered. At the four minute marker within the buffered segment the preceding part, about 30 seconds, is discarded so the segment after exactly 4 minutes remains. At the four minute marker within the saved portion the buffered part is immediately substituted. The play is largely unbroken in the switchover. Using markers within a program removes the need for precise external timing, and the time-shift of the segment need not be exactly known. A program remains portable as it is broken up and reassembled. The markers can be as close as capacity allows. For example they may be every second or 100th of a second. Such precise internal time keeping is known for music streams.

If parallel loops of a program episode are available as for Show 1 a user will be able to navigate within that episode. Even if already played portions are locally erased a fwd or replay action can move the play to a loop that started earlier or later. If the user is moving around in an episode the customizer may elect to save the recent play of Show 1 and 5 min from each earlier loop of Show 1. Then the user can move continuously to any part of Show 1.

Based on which shows a listener has selected before and which ones he has rejected, the customizer may load starting portions of suitable shows that are known to be available on other loop channels. Any station that is chosen for a preset on a user device may have any associated shows preloaded for immediate play. The frequency and availability of loop channels for a show will determine how much of the show must be preloaded. Conversely the popularity of a show will determine how many loops of it are available in a network and how often it starts. This feature of the invention helps balance the need for unique downloads of less popular items with the alternative of multiple parallel loops for popular items. It may be that a few shows account for an overwhelming portion of demand from users. Having only these in multiple parallel loops would free up Internet resources so the remaining less popular shows can be uniquely downloaded. The network operator may coordinate this balancing operation.

A station or program provider may coordinate a promotional campaign for its shows. This would include advertising the shows to users of the network and to the public at large. The show promoter may pay the network or other parties for resources to make available multiple loops of the show. They may further pay to have the start of the show saved in user devices. This would be a way to invite new listeners or viewers of a show.

A mass marketed advertisement, infomercial, or other long-playing promotional item can be made available in multiple broadcast streams or loops for immediate play on many user devices. A user is unlikely to be willing to wait for a promotion to download. So a station or provider may choose to pay to have this material broadcast in multiple streams or loops. He may further choose to pay to have initial portions preloaded into user devices. A short conventional ad within the user's regular play items or elsewhere can alert the user to this long-playing promotion. The user may further be informed that by playing or responding to the promotion, survey, infomercial etc., he can earn credits such as a period of future commercial free playing time on network stations. It may be common for a user to expect compensation for receiving or responding to long playing promotions.

If a requested program is not available on-demand for some reason the customizer may present other shows that are available for immediate play in the manner described above. The current station may select among the shows that the customizer presents as being available for immediate play. In this case the customizer selects material that is technically qualified for the current need, while the station selects from the qualified items based on style or content. Here the function of the customizer and the station are distinct; the customizer performs housekeeping duty including monitoring and managing local and outside resources, while the station or other provider selects among options identified by the customizer. The customizer and station can blend their functions, with the customizer applying the user's or the current station's preferences in selecting program candidates from various streams or memory. But a station would not normally be expected to manage a user's local resources.

A show will not always be available for immediate play. It may not be prepared, meaning partially or wholly preloaded, or not be available on any stream now. It may not be prepared because the user has never selected this type of show before. The user may receive a notice that a delay is required for a special download. He can continue turning the channel dial to channel “x” as in FIG. 3, or be automatically sent to the new channel, where Show 2 is streaming. If channel x comes from a cooperating station, the user's current station or customizer can know that Show 2 was about to start, and that it fits the user's or station's preferences. So a starting portion of Show 2 was buffered near the user. Therefore Show 2 begins immediately when its channel is selected. However this show is not a high enough priority to save its entire length. It has been allocated 6 minutes by the customizer or other entity. After 6 minutes it is erased and no longer immediately available. The channels displayed on a user device may provide only, or emphasize, shows that are available for immediate play. For example the list of immediately available shows is listed first, with downloadable shows listed later. This list could change even within one station as the starts of various singly and multiply streamed shows are saved and erased over time.

If the user has sought Show 1 and it was not available, it would be saved as soon as it is available from a cooperative stream. Or if the user indicates it is a priority it would be downloaded uniquely as system resources allow wherein the user is notified when it is ready.

In a form of cross-promotion or targeted advertising the listener is introduced to Show 2 as part of a new list of shows since Show 1 was not available. A listener seeking a particular regular program show is a good candidate to present relevant alternative shows. The user may not object if the reason for the alternative is that the desired show is not immediately available, while the alternative one is. Of course advertising or other types of material can be used during a waiting period. But a ten-minute or more wait filled with ads may cause a user to switch channels or stations unless he is compensated.

According to one variation a Top Channel comprising a playlist of long playing shows may be offered by a music or talk station in addition to the searchable show channels. This may be the primary Top channel of a talk show station. Using the playlist assembly method of the invention a non-searchable list of long shows is presented to a user similar to a music playlist. A user can modify the list to create sidechannels of shows according to preference of the station and/or user. If a large number of cooperating providers offer parallel streams and loops a customizer and/or current station can prepare alternate shows in case the user removes a current show. During any show, an alternate show is made available for immediate play as described earlier. Preferably several shows are identified by the customizer and prepared for play in case a few alternatives are sequentially rejected. If the user rejects too many in a row there may be no more available. However different station can be selected that has a Top channel or directs the customizer differently whereby more personally satisfying shows are played. The user will tend to return to the more satisfying station for shows. This same station will also likely have more preferred shows available for immediate play in the searchable channels

In the manner just described a user's sidechannel of shows may not entirely comprise programs on-demand but rather an ongoing personalized playlist of programs that are available in near real time from parallel playlists. Here regular programs can be treated similarly to music playlists where a personalized list of programs assembled to fit a listener's preferences. A user may indicate by a priority action that a show listed on the searchable program channel is desired. It will play as requested as soon as it becomes available from any accessible stream, likely from a network affiliate station, but also possibly from other sources. In this case, as described, the affiliated station provides advance notice to other affiliates of which shows are next, so a current station or customizer can prepare to buffer or store it. If various providers outside of the network cooperate, or even if they do not, they can also be sources for this material. A customizer or station may preload and store an entire program as it is broadcast if the user has listened to a previous episode of it before, and local memory allows. It may be available earliest if the station takes it from the first station or channel that it plays on. The latest episode is then immediately available on a station's Programs channel, or as an interruption if so requested.

The Channel dial can be used to select the various channel options discussed above. These may include Top Channel, Channel 2, My KXXX, My-SideKXXX, listed programs, a near real time assembled personal playlist of programs, and Specials. The station operator may wish to add more channel options, but would be advised by the network operator to design such offerings carefully to prevent confusing or inconsistent channel types.

Of course many variations on the use of the controls of the device of FIG. 1 are possible, as determined by the station and/or the user and allowed by the network operator. Also many variations on the design of the device of FIG. 1 are possible, including the particular control options. No specific type of device is required to use the playlist assembly method of the invention.

It is a feature of the invention that program providers who wish to use the method of the invention are free to interpret how to use it. In an earlier example, one station chose to use a removed selection as a basis for assembling a playlist, but did not include the item. Anther station may include it in the new list. This demonstrates a broader concept. The present invention provides a way to link, search for, and modify programming and information. However each affiliated Internet site or station, including a user's virtual station, that uses the method retains control over the programming that is offered. If a user listens to two similar music stations with similar playlists, removing the same selections from each may result in quite distinct sidechannel playlists. This is because the affiliates can interpret the negative user input in different ways within the method of the invention.

The network operator may provide each affiliate with software routines and systems including a customizer for creating or influencing customizers to direct assembly of modified playlists and other elements of the invention. These systems will preferably be designed to be flexible in how they are applied so each affiliate can use their own programming philosophy to help a listener modify a playlist.

One method to link to particular stations, entities, or other parties is to use a multipurpose addressing system. In one embodiment the address is a telephone number. Programming played according to the invention can easily be blended with telephony. Especially for businesses a phone number often represents a valuable identity. Further, a meaningful Internet domain address name may be unavailable. If a phone number is used instead it can serve double duty to access telephone systems and Internet programming and information. The network operator may provide a method to link customers wherein a phone number is translated to an Internet address of the same owner. A method to navigate by use of a numeric keypad may also be provided. A user may select whether he wants to be connected through the conventional telephone system or to the same entity's Internet operation. In one simple example a user may be given a choice to wait to speak to a live or virtual operator or to navigate offerings of the business by means of a device such as that of FIG. 1, a phone keypad or a special purpose network provided web page such as xxphone.com. Alternatively, a live operator may actively link a caller to an audible site of the business, such site comprising a node on the Internet. Using Internet methods the user becomes an interactive audio customer of the business. A device may include a control to select telephone or Internet access when a user enters the phone number. For audio programming and information a blend of telephony and audio programming is convenient. A fax number may be used as a multipurpose address.

The telephone number may further create a link to an individual's email account, where the link may be entirely independent of the telephone company that assigned the individual his telephone number. Rather the network operator uses the preexisting phone number to link to a user's email using Internet methods. Email may be read to a user by means of text to voice technologies

One way a station can control programming is by determining the function of the “Links” action or other action within the methods suggested by the network operator. The Links button may serve different functions at different points in time. In one example, as an advertisement plays Links may send the user to features controlled by the advertiser such as purchase options. Once the advertisement is finished a music station or other program provider may enable links to other areas such as a hidden playlist provider.

In one embodiment of the invention a user may know that a link is available by means of a tone that precedes or follows a specified word (or keyword) or other sound such as a musical element.

FIGS. 5 to 7 show specific displays that may appear when listening to an affiliated FM station. In FIG. 5 the category dial has been turned to FM LOCAL. The station dial has selected a local FM station KLOS. The term “Rock” may appear in the Category or Station line if KLOS has elected to provide that information. Such an identifier would be especially helpful when searching non-local radio stations. The channel dial has not been moved so the Top Channel is playing. However if the user has listened to this station before and had the channel set other than Top Channel it would preferably start in the channel where it had last been. The programming is from the station's standard signal, where the Beatles' Yellow Submarine is currently playing in FIG. 5A. In FIG. 5B the user has turned the channel to “Regular Programs”. Since the station is an affiliate this option is available. The band indicator adds xxMUSIC since the show selected is a music show and is a feature from of the network. FM band remains indicated to show that the station has a conventional FM operation.

If it is immediately available or has been locally downloaded the most recent “Sunday Show” episode starts playing in FIG. 5B. Of course it need not be Sunday to hear this show on this Program channel. Pressing and holding “send/fwd” will advance within this episode of “Sunday Show” up to the limit of what has been buffered. If an available parallel stream of this show includes an earlier starting time for the same show, a later portion of the show will be immediately accessible to the user. Tapping Send/fwd will not do anything since KLOS does not provide future episodes. But tapping Replay will access the previous episode, maybe from two Sundays ago. This would likely be a special download since the old episode may not be a popular selection. Holding replay will move the play toward the beginning of the current episode unless it has been locally erased to make room for other activities. For talk shows memory requirements are less limiting than for music selections.

Turning the channel dial further to the right will select a different show. If KLOS declares it a talk show the xxTALK band is indicated. If the type is music or not specified the band will remain at xxMUSIC as this is the main format of KLOS's Top channel. If neither the current show nor KLOS's main format is specified or is indeterminate then both xxbands will be indicated. Affiliates will be encouraged to specify a main type format as well as any differing programs. For almost any station or program this identity will not be vague. A show with minimal music and much talk about music would normally still be a music show, especially if a music format station is playing it. But such a show on a talk radio station would be a talk show. This distinction is useful since it helps focus a listener's subsequent searches and links from a site, and also may affect the type of data signal that is needed or provided.

Returning to FIG. 5, the display in FIG. 5C shows channel 2 playing. KLOS offers this additional music channel. Channel 2 is playing a particular music selection. This channel is to the left of the Program channels, in the respective position shown in FIG. 4. Here the DJ button has been pressed to remove DJ talk from the playlist. The modification techniques described above for the Top channel would be expected to work on this channel as well.

In FIG. 6 the creation of a personally modified channel is shown. A listener dislikes the currently playing song “Dreams”. Pressing “delete” moves the playlist from the Top channel to the new list “My KLOS”. The xxMUSIC band is added to show the new playlist is a feature of the network, and that the Top channel is no longer in use. The new “My KLOS” channel playlist is assembled by KLOS with the knowledge that the user never wants to hear “Dreams”.

In FIG. 7 the user likes to hear “Dreams” occasionally, but not as a prime choice. Pressing “Send/fwd” removes it from the newly created “My KLOS” as above, but a KLOS designed playlist is assembled knowing that the user occasionally likes “Dreams”. “My KLOS” will be playing, while the additional “Sidechannel” based on an occasional liking of “Dreams” is ready and accessible with the channel dial as in FIG. 7C. As discussed earlier the sidechannel playlist need not actually contain “Dreams”, but it is designed with the knowledge that that listener likes it occasionally in the context of the KLOS format. As discussed earlier the Send/fwd action upon the sidechannel will have the same effect as Delete, since it is normally not desired to create further sidechannels. But a station may offer unlimited sidechannel branches, where “send/fwd” creates ever-lower channels, if they feel their listeners will like it. As the “Send/fwd” and “Delete” actions continue KLOS has increasingly more information to use in personalizing a user's playlists.

According to the invention a station can customize a user's listening experience within the confines of that station's overall format. But a station can leverage its format into unique, or at least more distinct, sub formats suited to each listener. The network operator can provide the stations with tools to design the customized playlists using a station's own library and market intentions.

The playlist assembly method of the invention may be used for many types of programming. As described earlier, lists of music, shows, news, talk radio, and other traditionally radio like material can benefit from the method of the invention. The present invention also has utility for television, film, cartoons and other sequential visual media that is may be accessed or delivered via the Internet. In addition the present method may be used for information type material. For example location-based searches may be assisted by use of the invention. In a certain area or “cell” information relevant to the area can be looped on parallel streams. When a user is near the cell an introductory or index portion of information can be stored with the user. In the manner of FIG. 3, when the user requests information the starting portion begins to play while the most recently started loop containing the remaining portion is found, buffered and played. The user receives immediate and largely unbroken play of the information. This is an example of local wireless broadcast streams being used as a source of material for the method of the invention.

Some location searches can be local restaurants or movie theaters. A restaurant may pay to have an introduction stored into devices of passing users of the invention. The information may be erased as the user leaves the area to make room for the next cell. If appropriate they may also pay to have their information looped frequently in the nearby area. Looping may be necessary if the business has a large amount of information to send and/or the user's device memory is expected to be filled with other data. Otherwise the information may be entirely loaded into the user device. If the user requests a search of nearby restaurants, the businesses that are preloaded and possibly looped have their information played immediately.

A movie theater may wish to play previews to passing cars, at least the audio portion. The preview can start from the beginning if the start portion is preloaded and the remainder is looped frequently. A user may be able to select different channels of previews when the signal is available.

A company with a nationwide or worldwide promotion can also use the method. The company or its agent can pay to have the start portion of its promotion preloaded into at least devices of users of network affiliates. The remainder is looped frequently on the general Internet. The promotion is then available for immediate play everywhere a network user goes. A bidding arrangement can a designed within the network wherein an advertiser, optionally with frequent loops, pays for the opportunity to be partly or wholly preloaded and available for immediate play on user devices.

1. A method for creation of a personalized playlist of programming, the playlist comprising sequentially played identifiable items of content from available sources of program material wherein:
a user selects a base channel that includes a playlist of content that may be played on a user device, the playlist of the base channel being immediately unchangeable and identical for a plurality of users;
alternate sources of content offer items that are continuously available for use as substitutions for items of the playlist of the base channel as the base channel plays, at least one substitute item being used in the personalized playlist;
the user reacts to items of the playlist of the base channel, whereby a side channel distinct from the base channel is created that reflects a user preference, the user preference defined at least in part by a user's reactions to items that have played on either of the base channel or the side channel, the side channel including the personalized playlist and being assembled substantially from items of the base channel and the alternate sources;
a customizer operates with the user device to determine in near real time which substitute items are included in the personalized playlist, the customizer using at least two criteria to define a sequence of items to play in the personalized playlist, a first criteria comprising the user preference, and a second criteria comprising the time availability of items provided by the alternate sources near the moment the customizer determines that a substitute item should be included in the sequence of items played;
a first suitable item from a first alternate source being buffered in a memory facility linked to the user device before the first suitable item is needed for use in the side channel, the first suitable item being unidentified to the user unless it is played on the user device;
the base channel and the alternate source of content are streaming broadcast sources that are available to a plurality of users of a data system;
an undesired item is streamed by a provider of programming on either of the base channel or the side channel, the undesired item is identified by the customizer as not meeting the first criteria, and the first suitable item plays on the side channel from a beginning of the first suitable item as a substitute for the undesired item;
the user device is configured whereby the listener may immediately select either one of the base channel and the side channel.

2. The playlist creation method of claim 1 wherein a second suitable item is streamed from a second alternate source at a beginning later than a beginning of the first suitable item streamed by the first alternate source, and the second suitable item begins at the second alternate source before it is needed for play on the side channel, the second suitable item being a better fit to the first criteria than the first suitable item, the first suitable item being removed from the memory facility in favor of the second suitable item.

3. The playlist creation method of claim 1 wherein the substitute items have two distinct types of value, a value of creative content and an opportunity value of time availability for use as a substitute item in the side channel.

4. The playlist creation method of claim 3 wherein a provider of the alternate source receives an opportunity value payment from a provider of the base channel when an item from the alternate source is substituted into the personalized playlist.

5. The playlist creation method of claim 1 wherein an alternate source comprises a hidden channel, the hidden channel is not available for use as a base channel, and the hidden channel serves a primary function to provide items of content as components for use in assembling personalized playlists.

6. The playlist creation method of claim 1 wherein the programming is audio programming, the undesired items of content are audio commercial announcements, and substitute items are used to replace the audio commercials.

7. The playlist creation method of claim 1 wherein a provider of the base channel is identified on a display screen of the user device.

8. The playlist creation method of claim 1 wherein the user preference comprises a set of instructions that is stored on a device of the user, the instructions being used to guide the customizer in a selection of items for the user.

9. A method for creation of a personalized playlist of programming, the playlist comprising sequentially played identifiable items of content from available sources of program material wherein:
a user selects a base channel from a streaming broadcast source that includes a playlist of content that may be played on a user device, the playlist of the base channel being immediately unchangeable and identical for a plurality of users;
alternate sources of content offer items that are continuously available for use as substitutions for items of the playlist of the base channel as the base channel plays, at least one substitute item being used in the personalized playlist;
the user reacts to items of the playlist of the base channel, whereby a side channel distinct from the base channel is created that reflects a user preference, the user preference defined at least in part by a user's reactions to items that have played on either of the base channel or the side channel, the side channel including the personalized playlist and being assembled substantially from items of the base channel and the alternate sources;
a customizer operates with the user device to determine in near real time which substitute items are included in the personalized playlist, the customizer using at least two criteria to define a sequence of items to play in the personalized playlist, a first criteria comprising the user preference, and a second criteria comprising a time availability of items streamed by the alternate sources near the moment the customizer determines that a substitute item should be included in the sequence of items played;
a suitable item from an alternate source being buffered in a memory facility linked to the user device before the suitable item is needed for use in the side channel, the suitable item being unidentified to the user unless it is played on the user device;
the user reacts negatively to an undesired item of content, and the suitable item plays on the side channel from a beginning of the suitable item immediately after an occurrence of the user's negative reaction;
the user device configured whereby the listener may immediately select either one of the base channel and the side channel.

10. The playlist creation method of claim 9 wherein an alternate source comprises a hidden channel, the hidden channel is not available for use as a base channel, and the hidden channel serves a primary function to provide items of content as components for use in assembling personalized playlists.

11. The playlist creation method of claim 9 wherein the substitute items have two distinct types of value, a value of creative content and an opportunity value of time availability for use as a substitute item in the side channel.

12. The playlist creation method of claim 11 wherein a creator of an item of content receives a royalty payment when the item is used in a playlist of the side channel, and a provider of the alternate source receives an opportunity value payment when an item from the alternate source is substituted into the personalized playlist.

13. The playlist creation method of claim 9 wherein the user preference comprises a set of instructions that is stored on a device of the user, the instructions being used to guide the customizer in an initial selection of items for the user.

14. A method for creation of a personalized playlist of programming, the playlist comprising sequentially played items of content wherein:
a user selects a streaming broadcast top channel that includes a playlist of content that may be played on a user device, the top channel being provided by a station that is operated independently of the user, the playlist of the top channel being immediately unchangeable and identical for a plurality of users;
an alternate streaming broadcast source of content is available from which substitute items may be obtained to modify the playlist of the top channel, the substitute items being used in the personalized playlist;
the personalized playlist comprises a combination of items from the top channel with the substitute items, a customizer operating with the user device to determine in near real time which substitute items are included in the personalized playlist;
a beginning point of an item of the alternate source is stored in a computer memory facility immediately accessible by the user device, and further component segments of the item of the alternate source are buffered in a computer memory facility, an identity of the stored item being known by the customizer in advance of the stored item being included in the personalized playlist;
the stored item being played as part of the personalized playlist on the user device from the beginning point of the stored item;
the alternate source comprises a hidden channel, the hidden channel is not available for use as a top channel, and the hidden channel serves a primary function to provide items of content as components for use in assembling personalized playlists.

15. The playlist creation method of claim 14 wherein the substitute item has two distinct types of value, a value of creative content, and an opportunity value of time availability for use as a substitute item in the personalized playlist, and a provider of the hidden channel receives an opportunity value payment when the item from the hidden channel is used in the personalized playlist.

16. A method for creation of a personalized playlist of programming, the playlist comprising sequentially played items of content wherein:
a user selects a streaming broadcast top channel that includes a playlist of content that may be played on a user device, the top channel being provided by a station that is operated independently of the user, the top channel being available to a plurality of users of a data system;
an alternate streaming broadcast source of content is available from which substitute items may be obtained to modify the playlist of the top channel, the substitute items being used in the personalized playlist;
the personalized playlist comprises a combination of items from the top channel with the substitute items, a customizer operating with the user device to determine in near real time which substitute items are included in the personalized playlist;
a beginning point of an item of the alternate source is stored in a computer memory facility immediately accessible by the user device, and further component segments of the item of the alternate source are buffered in a computer memory facility, an identity of the stored item being known by the customizer in advance of the stored item being included in the personalized playlist;
the stored item being played as part of the personalized playlist on the user device from the beginning point of the stored item;
the substitute items have two distinct types of value, a value of creative content and an opportunity value of time availability for use as a substitute item in the personalized playlist, and a provider of the alternate source receives an opportunity value payment from the station when the item is used in the personalized playlist.

17. The playlist creation method of claim 16 wherein the station operates as an affiliate of a cooperative network with other stations, and the affiliate stations share resources in the course of assembling playlists for listeners of affiliate stations.

18. The playlist creation method of claim 16 wherein the customizer is guided by a combination of a user's own preferences and a style of the station when the customizer performs substitutions of items of content into the personalized playlist.

19. The playlist creation method of claim 16 wherein an identity of the station is displayed on the user device.

20. A method for navigating the programming of an audio program provider affiliated with a network of other providers in which the provider presents to a user a standardized method for searching, selecting and playing programming, the standardized method being specified by a network operator wherein:
the provider offers a top channel accessible simultaneously by a plurality of users, wherein each user receives substantially a same playlist;
a user reacts to program items that are played on the top channel, a cumulative history of a user's reactions comprising a user preference;
the provider offers an ability to create a first side channel wherein an alternate personal playlist is already prepared when the user reacts in a first manner to a program item of the top channel;
the first side channel includes programming that reflects a combination of a style of the provider of the selected top channel, and the user preference, wherein the user creates a personal playlist of programming in near real time during the course of listening and reacting to a channel of the program provider;
the standardized method includes a multipurpose addressing system using telephone numbers, a telephone number serving at least two functions: a first function being to access a remote voice telephone device, and a second function being to access the programming of the program provider, the program provider thereby being identified by a multipurpose telephone number;
the user being able to use a device to select which of the two functions are served by the telephone number.

21. The navigation method of claim 20 wherein the device includes a numeric keypad, and the network operator provides to the user a template, the template providing instructions relating keys of the keypad to navigating functions, the navigating functions including searching and selecting programming from the program providers affiliated with the network of providers.

22. The navigation method of claim 21 wherein the device includes a wireless telephone.
